(19) United States
(12) Patent Application Publication
(10) Pub. No.: US 2006/0264079 A1
(43) Pub. Date: Nov. 23, 2006

(54) Adjustable support for electronic device cradle

(76) Inventors: Sean N. Davie, Lawrenceville, GA (US); William C. Phelps III, Lawrenceville, GA (US); Robert N. Stanford, Flowery Branch, GA (US)

Correspondence Address: MOTOROLA, INC.;LAW DEPARTMENT, 600 NORTH U.S. HIGHWAY 45, AS437, LIBERTYVILLE, IL, 60048, US

(21) Appl. No.: 11/172,022

(22) Filed: Jun. 30, 2005

Related U.S. Application Data
(60) Provisional application No. 60/681,819, filed on May 17, 2005.

(51) Int. Cl. H01R 13/44

(52) U.S. Cl. 439/131

(57) ABSTRACT

A holder for an electronic device is provided. The holder accommodates a variety of electronic devices, each electronic device having a different form factor. A rotatable, spring loaded pin is included with the holder. The pin has projections that extend distally from the pin and intersect a graduated base member. When the pin is rotated, the projections move along the graduated base member so as to cause the pin to protrude more or less into the pocket of the holder. This rotation and corresponding pin protrusion height allows the cradle to accommodate electronic devices having different form factors, while providing a support that is fully captured or enclosed by the assembly of the accessory.

### CROSS REFERENCE TO PRIOR APPLICATIONS

This application claims priority under 35 U.S.C. § 119(e) from U.S. Provisional Application Ser. No. 60/681,819, filed May 17, 2005, entitled “Adjustable Support for Electronic Device Cradle”, which is incorporated herein by reference.

### BACKGROUND

1. Technical Field

This invention relates generally to holders of electronic devices, and more specifically to a holder for an electronic device having a rotatable, adjustable support to facilitate accommodation of electronic devices having different thicknesses.

2. Background Art

Electronic devices receive their portable power from rechargeable batteries. These batteries come in different sizes and shapes. When attached to an electronic device, the size and shape of the battery will affect the overall shape of the device. For example, when a thick battery is attached to a device like a mobile telephone, the overall device will be thicker than when a thin battery is attached.

Additionally, electronic device manufacturers sometimes make a family of devices, where each device in the family has a slightly different overall form factor. In other words, in a given product line, each product may include a common design theme or identifier, but may take on a slightly different size or shape. In the world of portable communication devices, for example, one model may include more features or a more rugged case, which may make the overall device thicker than others in the product line.

This varying size and shape creates a problem for accessory manufacturers. With different form factors, each different electronic device requires a differently shaped accessory. For example, an accessory manufacturer who makes holders or cradles must make different holders for each electronic device. If a device is thick, the accessory manufacturer may need to make a holder with a deep pocket. If the device is thin, the accessory manufacture may need to make a holder with a shallow pocket.

This one to one relationship of a unique accessory for each electronic device creates two problems. First, electronic device manufacturers would prefer to have a standard accessory line. This is because the manufacturer wants a customer to be able to easily upgrade electronic devices without the need of completely re-accessorizing. Second, building many different products, some of which may have low volumes, is both expensive and time consuming.

There is thus a need for an improved accessory that accommodates multiple electronic devices having multiple form factors.

### BRIEF DESCRIPTION OF THE DRAWINGS

FIG. 1 illustrates a pin in accordance with the invention.

FIG. 2 illustrates a holder, or cradle, in accordance with the invention.

FIG. 3 illustrates a sectional view of a holder in accordance with the invention.

FIG. 4 illustrates a rear, sectional view of a holder in accordance with the invention.

FIG. 5 illustrates a sectional view of an electronic device coupled to a holder in accordance with the invention.

FIG. 6 illustrates a sectional view of an electronic device coupled to a holder in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

As is illustrated in the figures and described below, a holder or cradle for an electronic device is provided. The cradle is designed such that it can mechanically accommodate any of a plurality of electronic devices, each of which may have a unique form factor. In one embodiment, the cradle includes an adjustable support for accommodating electronic devices having multiple form factors. The adjustable support, referred to often herein as the “pin”, is a moveable device that, when moved, extends farther into or out of the pocket.

In one embodiment, the pin is rotatable. The pin, which is disposed within a pin support, includes one or more protrusions that extend distally from the sides of the pin. When rotated, the pin moves along a graduated, stair stepped section of the pin support, such that the protrusions, riding along the graduated pin support, cause the pin to protrude more or less into the pocket of the cradle. The graduations may be accommodated by corresponding predetermined stops. When barriers, which project outwardly from the sides of the pin, intersect with the predetermined stops, the predetermined stops provide a slight frictional force to keep the projections securely along one of the graduations.

The pocket may include visual indicators to indicate to a user upon which graduation, or upon which predetermined stop, the projections are resting. By twisting the pin in a first direction, the cradle will accommodate an electronic device having a first form factor, e.g. a thin electronic device. By twisting the pin in a second direction, the cradle will accommodate an electronic device having a second form factor, e.g. one that is thick. The pin may be spring loaded, with respect to the cradle, so as to reliably stay in place in each predetermined stop or graduation.

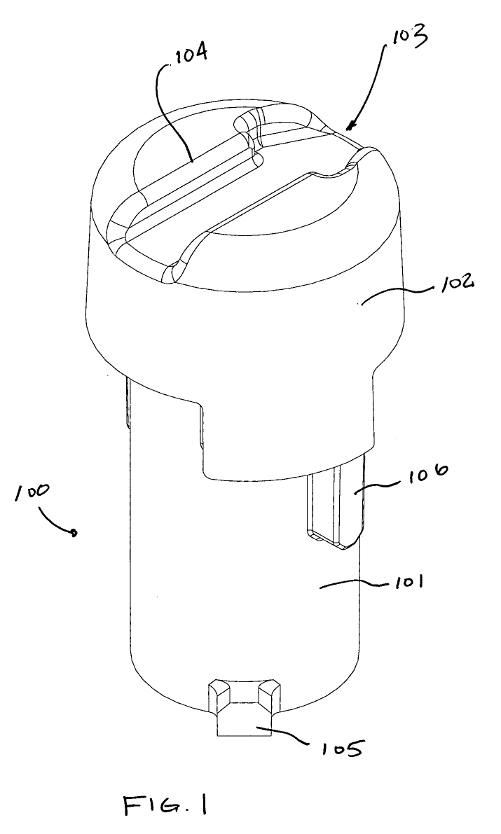

Turning now to FIG. 1, illustrated therein is one embodiment of a pin 100 in accordance with the invention. The pin 100, which may be made of a solid plastic like ABS, polycarbonate or polycarbonate-ABS by way of an injection molding process, includes a shaft 101 and an end 102. The end 102 is designed to provide support to the electronic device when inserted into the cradle. The shaft 101 will be disposed within the cradle in the final assembly.

To facilitate ease of rotation, the end 102 may include a notched groove 103. The notched groove 103, which may accommodate a tool or other implement to assist in turning the pin 100, provides additional friction against a user's finger for easier turning. It will be clear to those of ordinary skill in the art having the benefit of this disclosure that the invention is not so limited. As an alternative to the notched groove, one may employ a raised surface, or center protrusion, rather than the notched groove.

In one embodiment, as will be discussed below, the pocket of the cradle may include visual indicators that indicate in which orientation the pin 100 should be for a particular electronic device. For instance the visual indicators may be words that read “Model A”, “Model B”, “Model C”, etc. Alternatively, the visual indicators may say “Thin Model” and “Thick Model”. Where visual indicators are employed, the notched groove 103 may be structured in a visually indicative shape, such as the arrow 104 illustrated in FIG. 1.

The pin 100 includes at least one projection 106 that extends distally from the shaft 101 of the pin 100. For additional stability, two or more projections 106 may be used. Where two projections 106 are used, it is desirable to dispose them on opposite sides of the shaft 101. The projections 106 may be located along the shaft of the pin 100, while the notched groove may be located at the end. Some designers may prefer to locate the projections 106 at the end of the shaft 101 opposite the end having the notched groove 103.

To ensure that the pin 100 stays within the confines of the base member in which it is inserted, mechanical barriers 105 may be included along the pin 100. As will be seen below, in one embodiment, the pin 100 is spring loaded. The barriers 105 ensure that the pin 100 stays within the confines of the cradle, even though loaded with the spring's force. Additionally, where predetermined stops are employed, the barriers 105 intersect with the predetermined stops to ensure that the pin stays at a predetermined height relative to the bottom of the cradle.

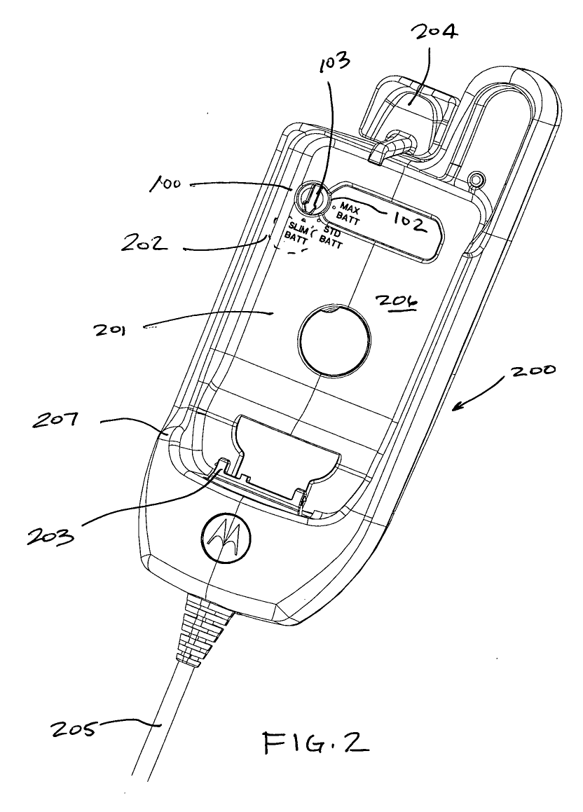

Turning now to FIG. 2, illustrated therein is one embodiment of a cradle 200, or “holder”, in accordance with the invention. The cradle 200, which may be manufactured from a rigid plastic by way of an injection molding process, includes at least one pocket 201 for accommodating at least one electronic device. The pocket 201 has a bottom 206 that is a fixed distance beneath (when viewed looking into the page) the outer surface 207 of the cradle 200. The bottom 206 is situated deep enough that the largest electronic device in the family for which the cradle 200 is designed will fit within the pocket 201.

The cradle 200 may include mechanical infrastructure for holding the electronic device securely within the pocket 201. In this embodiment, a spring actuated mechanical latch 204 is provided to hold the electronic device. The cradle 200 may further include electrical circuitry disposed within the cradle 200 for charging and/or communicating with the electronic device. For example, one application well suited for a cradle 200 in accordance with the invention is as a vehicular power adaptor for a mobile telephone. In such an application, the cradle 200 may include power conversion, charging or safety circuitry for supplying the electronic device with power. The cradle 200 may draw power from the vehicle through a power cord 205 coupled to the cradle. This power may then be delivered to the electronic device by a power connector 203 disposed within the pocket 201 of the cradle 200.

As shown, the pin 100 is disposed within the pocket 201. The pin 100 is capable of providing mechanical support to electronic devices that are not as thick as the pocket 201 is deep. The pin 100 is disposed within the cradle 200 such that the top 102, which represents a first end of the pin 100, projects through an aperture in the pocket 201. As will be explained in greater detail below, when the pin 100 is rotated in a first direction, the pin 100 moves farther into the pocket 201. When the pin 100 is rotated in the opposite direction, the top 102 of the pin 100 moves closer to the bottom 206 of the pocket 201.

Visual indicators 202 may be included to indicate in which rotational orientation the pin 100 should be for the particular electronic device. By rotating the pin 100 such that the notched groove 103 (illustrated in FIG. 2 as an arrow) aligns with a particular visual reference indicator, the user knows that the pin 100 protrudes into the pocket 201 at such an amount as to securely support his particular electronic device. In the application of a vehicular power adaptor for a portable telephone, one visual indicator may correspond to a phone having a thin, or slim, battery. A second visual indicator may correspond to a phone having a standard battery. A third visual indicator, which may mean that the end 102 of the pin 100 is flush with the bottom 206 of the pocket 201, may correspond to a phone having the thickest battery coupled thereto.

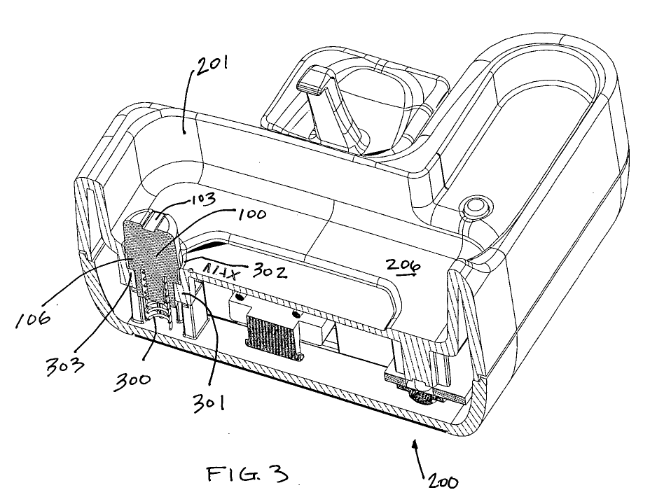

Turning now to FIG. 3, illustrated therein is a sectional view of one embodiment of a cradle 200 in accordance with the invention. As can be seen in this cut away view, the pin 100 has been disposed within the cradle 200 such that the end 102 of the pin 100 protrudes through an aperture 302 in the bottom 206 of the pocket 201. The pin 100 is disposed within a graduated base member 301.

This base member 301, or pin support, includes graduations 303 which are essentially stair-stepped features in the pin support 301. These graduations 303, which provide a mechanical support to the projections 106, cause the pin 100 to move further or less into the pocket 201 when rotated. (It will be clear to those of ordinary skill in the art having the benefit of this disclosure that the graduations, as the term is used herein, may be as simple as an inclined plane upon with the projections 106 ride when the pin 100 is rotated.) The pin 100 is loaded by way of a spring 300 so as to keep the pin reliably positioned within the cradle 200. The spring 300 is disposed between the cradle 200 and the pin 100.

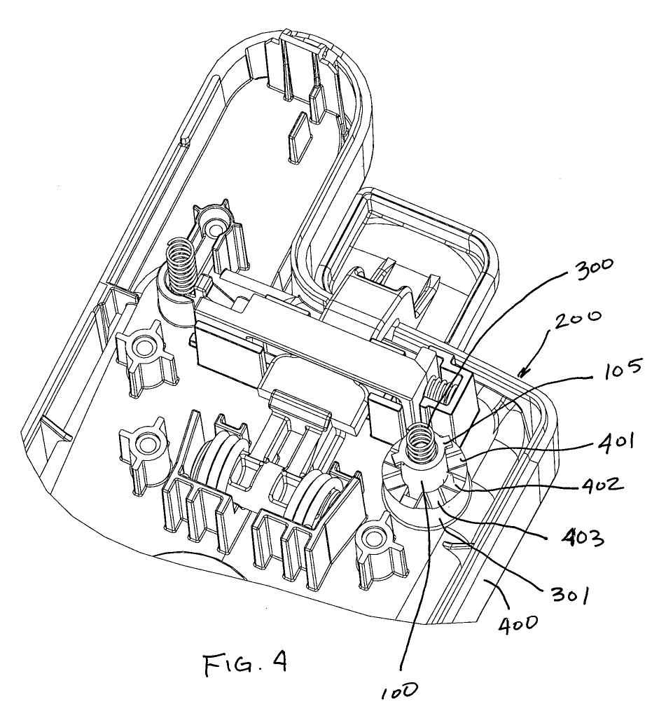

Turning now to FIG. 4, illustrated therein is an underside, sectional view of the top half of a cradle housing 400 in accordance with the invention. From this view, the predetermined stops 401-403 may be seen. In this embodiment, the graduations are complimented by a plurality of predetermined stops 401-403, which are detents in the pin support 301, that correspond to the visual indicators in the pocket. For example, a first stop 401 may correspond to a first graduation (located on the opposite side of the pin support 301) and its associated visual indicator. This graduation/stop combination causes the pin 100 to protrude into the pocket the maximum amount, while a second stop 402 (and corresponding graduation) may cause the pin 100 to protrude into the pocket a moderate amount. A third stop 403 (and corresponding graduation) may cause the pin 100 to be flush with the bottom of the pocket.

As can be seen, the predetermined stops 401-403 may be as simple as detented notches along the pin support 301 that provide frictional resistance to the spring loaded pin 100. As the pin 100 is spring loaded, the spring 300 pushes the barriers 105 against the base of the pin support 301, and thus against the stops 401-403. As the pin 100 is rotated, the barriers 105 pass through the stops, while the projections (105) pass along the graduations on the opposite side of the pin support 301. The pin 100 may be rotated such that the barriers 105 move in and out of the stops 401-403 by slightly compressing the spring 300.

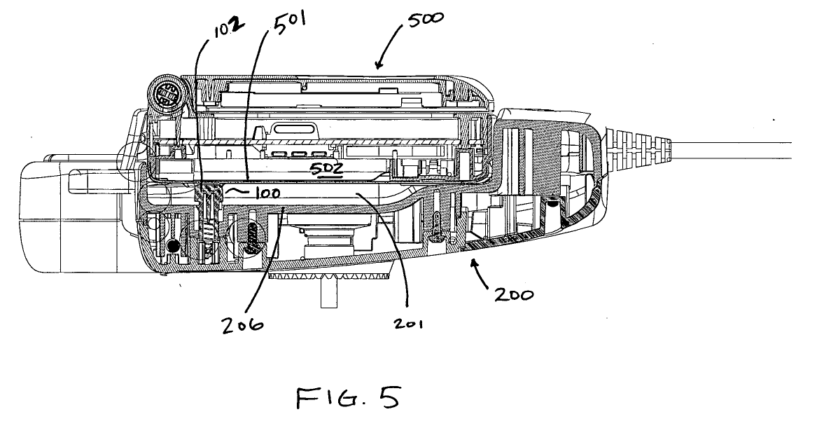

Turning now to FIG. 5, illustrated therein is an electronic device 500 that has been inserted into a cradle 200 in accordance with the invention. For illustrative purposes, the electronic device 500 shown is a mobile telephone having a thin battery 502 coupled thereto. It will be clear to those of ordinary skill in the art, however, that the invention is not so limited. Such a cradle 200 may accommodate any of a variety of electronic devices, including pagers, PDAs, MP3 players, two way radios and the like.

As can be seen in the sectional view of FIG. 5, the phone 500 has a thin battery 502 attached thereto. As such, the phone/battery combination 500/502 is not as deep as is the pocket 201. For the cradle 200 to accommodate this phone 500, the pin 100 must be rotated such that the end 102 protrudes into the pocket 201. The end 102 of the pin 100 then contacts the back 501 of the phone 500, thereby providing secure support. Note that in this configuration, the back 501 of the phone 500 is suspended above the bottom 206 of the pocket 201.

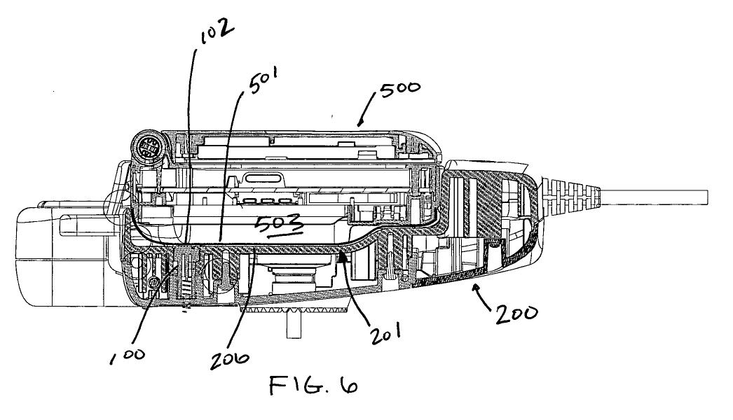

Turning now to FIG. 6, illustrated therein is an electronic device 500 having a thick battery 503 coupled thereto inserted into a cradle 200 in accordance with the invention. Here, the thickness of the phone/battery combination 500/503 that it fills the entire pocket 201. To accommodate such a phone 500, the pin 100 must be rotated such that the end 102 is flush with the bottom 206 of the pocket. As such, the back 501 of the phone 500 is allowed to rest against the bottom 206 of the pocket 201.

To recap, a cradle is provided having a rotatable pin that provides support to electronic devices. The pin may be spring loaded such that the button is always pushing against the bottom of the electronic device when attached to the cradle. The pin rotates about a center axis. The pin is disposed within a graduated base member, which may include several predetermined stops. The stops are detented positions about the circumferential, graduated path of rotation. Each detented position establishes a unique minimum displacement height for the pin into the pocket. This displacement is determined by the intersection of protrusions that extend distally away from the pin and the stops.

The orientation of the pin can be preset to accommodate an electronic device with a specific thickness. This is done by rotating the pin into the proper detent position. When the electronic device is inserted into the pocket of the cradle, the back of the device pushes the button in the opposite direction of the spring force until the battery support hits its hard stop position. This stabilizes the phone for each unique electronic device configuration.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

What is claimed is:

1. A holder for an electronic device, the holder comprising:
a. a pocket;
b. a rotatable pin; and
c. a graduated base member;
wherein when the pin is rotated in a first direction, the pin protrudes farther into the pocket;
further wherein when the pin is rotated in a second direction, the pin protrudes less into the pocket.

2. The holder of claim 1, wherein the pin comprises at least one projection that extends distally from the pin.

3. The holder of claim 2, wherein the at least one projection intersects the graduated base member.

4. The holder of claim 3, further comprising a spring disposed between the holder and the pin.

5. The holder of claim 3, wherein the pin is spring loaded.

6. The holder of claim 5, wherein the pin comprises a notched groove at a first end of the pin.

7. The holder of claim 6, wherein the at least one projection is disposed along a shaft of the pin.

8. The holder of claim 6, wherein the notched groove comprises an arrow.

9. The holder of claim 8, wherein the holder comprises visual indicators disposed within the pocket, wherein each visual indicator corresponds to a stop location of the pin.

10. The holder of claim 9, wherein the stop location corresponds to a predetermined electronic device configuration.

11. A cradle for a two-way communications device, the cradle comprising:
a. at least one pocket capable of accommodating at least one electronic device;
b. a pin capable of providing mechanical support to the at least one electronic device; and
c. a graduated pin support;
wherein when the pin is moved in a first direction within the graduated pin support, a first end of the pin moves farther from the at least one pocket capable of accommodating the at least one electronic device.

12. The cradle of claim 11, wherein the pin is spring loaded relative to the cradle.

13. The cradle of claim 12, wherein the pin is disposed within the graduated pin support.

14. The cradle of claim 13, wherein the graduated pin support comprises a plurality of predetermined stops.

15. The cradle of claim 14, wherein the pin includes at least one projection extending from the pin.

16. The cradle of claim 15, further comprising at least one barrier, wherein the at least one barrier passes through the predetermined stops as the pin is rotated.

17. The cradle of claim 16, wherein the pocket capable of accommodating the at least one electronic device comprises visual indicators, the visual indicators corresponding to pin positions where the at least one barrier interfaces with one of the plurality of predetermined stops.

18. The cradle of claim 17, wherein each of the visual indicators corresponds to an electronic device configuration.
